(19) United States
(12) Patent Application Publication
(10) Pub. No.: US 2009/0181279 A1
(43) Pub. Date: Jul. 16, 2009

(54) FUEL FOR FUEL CELL, AND FUEL CELL SYSTEM

(75) Inventors: Haruyuki Nakanishi, Susono-shi (JP); Norihiko Nakamura, Mishima-shi (JP); Shinichi Matsumoto, Fuji-shi (JP); Hidekazu Arikawa, Susono-shi (JP); Kazuya Uchisasai, Susono-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/354,390

(22) Filed: Jan. 15, 2009

(30) Foreign Application Priority Data
Jan. 15, 2008 (JP) 2008-006032

(51) Int. Cl. H01M 8/10

(52) U.S. Cl. 429/30; 44/457; 44/300

(57) ABSTRACT

Fuel for a fuel cell includes a main fuel that includes at least hydrogen and carbon, and a fuel additive formed of a hydrogen-containing compound that has a redox potential lower than that of hydrogen. A fuel cell system includes an electrolyte, an anode arranged on one side of the electrolyte and a cathode arranged on the other side of the electrolyte, and a fuel supply source that supplies the main fuel and the fuel additive.

### INCORPORATION BY REFERENCE

The disclosure of Japanese Patent Application No. 2008-006032 filed on Jan. 15, 2008, including the specification, drawings and abstract is incorporated herein by reference in its entirety.

### BACKGROUND OF THE INVENTION

1. Field of the Invention

The invention relates to fuel for a fuel cell, and a fuel cell system. More particularly, the invention relates to fuel for a fuel cell in which material that includes hydrogen and carbon is used as the main fuel, and a fuel cell system that generates power using that fuel.

2. Description of the Related Art

In a fuel cell in which hydrogen ions (H⁺) are used as the conductor, for example, fuel that is supplied is broken down into hydrogen ions and electrons at the anode. The hydrogen ions are conducted through an electrolyte solution to the cathode, where they bond with oxygen supplied from the cathode. Meanwhile, the electrons pass through an external electrical circuit via a fuel electrode to the cathode, during which time they perform work with respect to a load on the external electrical circuit, thereby generating energy. Therefore, to improve the power generating performance of the fuel cell, it is necessary to efficiently break the fuel supplied to the anode of the fuel cell down into many hydrogen ions and electrons.

Regarding this, Japanese Patent Application Publication No. 2004-288378 (JP-A-2004-288378), for example, describes a fuel cell that uses hydrazine as fuel. This fuel cell uses an anode in which a film of hydrogen storing alloy is formed through sputtering or the like on the surface of collector material that is formed of metal foam such as Ni foam. According to this related art, a large reaction area for the catalyst of the anode can be ensured while the breakdown activity of the hydrazine by the hydrogen storing alloy is able to be further increased. Therefore, the supplied hydrazine is able to be oxidized to generate efficiently hydrogen ions.

Incidentally, this related art relates to a hydrazine fuel cell with a structure in which the anode is immersed in an electrolyte solution. However, there are a variety of fuel cells such as alkaline fuel cells that use hydroxide ions as the conductor. There are also a large variety of fuels used in these fuel cells.

Here, in particular, fuel cells that use fuel containing carbon produce carbon dioxide (CO₂) and the like in the process of breaking down the fuel. Also, carbon dioxide is also present in the atmosphere. Therefore, even with an alkaline fuel cell, the electrode and electrolyte and the like are exposed to an acid environment while the fuel cell is operating. As a result, when the fuel cell is operated for an extended period of time, the electrode and electrolyte membrane degrade, reducing the breakdown activity at the electrode and the like, which may reduce the output of the fuel cell. Therefore, various types of fuel cells which offer good fuel breakdown performance at the anode and which have good durability in which they are able to maintain that performance even when operated for an extended period of time are desired.

### SUMMARY OF THE INVENTION

This invention thus provides a fuel for a fuel cell which breaks down efficiently at the anode and is capable of keeping the power generating performance of the fuel cell high even when the fuel cell is operated for an extended period of time, as well as a fuel cell system that generates power using this fuel.

A first aspect of the invention relates to fuel for a fuel cell, which includes a main fuel that includes at least hydrogen and carbon, and a fuel additive formed of a hydrogen-containing compound that has a redox potential lower than that of hydrogen.

According to this structure, the fuel for a fuel cell includes a main fuel that includes at least hydrogen and carbon, and a fuel additive formed of a hydrogen-containing compound that has a redox potential lower than that of hydrogen. Supplying this kind of fuel enables degradation of the fuel cell to be suppressed because the breakdown efficiency of the fuel at the anode of the fuel cell increases and the electrolyte and anode and the like of the fuel cell that have become oxidized can be reduced. Therefore, high power performance of the fuel cell can be maintained even when the fuel cell is operated for an extended period of time.

In the fuel for a fuel cell according to this aspect, the fuel additive may include a salt that makes an aqueous solution alkaline or neutral.

According to this structure, including this kind of fuel additive in the fuel for a fuel cell more reliably increases the breakdown efficiency of the fuel at the anode and enables the electrolyte and the catalyst and the like that have degraded due to oxidation to be reduced. As a result, high power performance of the fuel cell can be maintained even when the fuel cell is operated for an extended period of time.

In the fuel for a fuel cell according to this aspect, the fuel additive may include an alkali metal or an alkaline earth metal.

In the fuel for a fuel cell according to this aspect, the fuel additive may include at least one selected from the group consisting of NaH₂PO₂, NaH₂PO₄, Na₂HPO₄, KH₂PO₂, KH₂PO₄, K₂HPO₄, and NaBH₄.

In the fuel for a fuel cell according to this aspect, the percentage of the fuel additive with respect to the main fuel may be within a range of 3% to 15%, inclusive.

The fuel for a fuel cell according to this aspect may also include a conductive agent formed of ion-conducting material.

According to this structure, including the conductive agent in the fuel for a fuel cell enables an adequate three-phase boundary to form around the catalyst particles of the anode. Therefore, the catalyst of the anode can be utilized effectively so that a larger reaction site area can be maintained, which in turn enables the power performance of the fuel cell to be improved.

A second aspect of the invention relates to a fuel cell system that includes an electrolyte, an anode arranged on one side of the electrolyte and a cathode arranged on the other side of the electrolyte, and a fuel supply portion which supplies a main fuel that includes at least hydrogen and carbon, and a fuel additive formed of a hydrogen-containing compound that has a redox potential lower than that of hydrogen, to the anode.

According to this structure, the fuel cell system includes an anode arranged on one side of the electrolyte and a cathode arranged on the other side of the electrolyte, and a fuel supply portion which supplies a main fuel that includes at least hydrogen and carbon, and a fuel additive formed of a hydrogen-containing compound that has a redox potential lower than that of hydrogen, to the anode. As a result, the breakdown efficiency of the anode of the fuel cell can be increased and the oxidized electrolyte and anode and the like of the fuel cell can be reduced, which enables high power performance of the fuel cell to be maintained even when the fuel cell is operated for an extended period of time.

In the fuel cell system according to this aspect, the fuel additive may include a salt that makes an aqueous solution alkaline or neutral.

According to this structure, including this kind of fuel additive in the fuel for a fuel cell more reliably increases the breakdown efficiency of the fuel at the anode and enables the electrolyte and the catalyst and the like that have degraded due to oxidation to be reduced. As a result, high power performance of the fuel cell can be maintained even when the fuel cell is operated for an extended period of time.

In the fuel cell system according to this aspect, the fuel additive may include an alkali metal or an alkaline earth metal.

In the fuel cell system according to this aspect, the fuel additive may include at least one selected from the group consisting of NaH₂PO₂, NaH₂PO₄, Na₂HPO₄, KH₂PO₂, KH₂PO₄, K₂HPO₄, and NaBH₄.

In the fuel cell system according to this aspect, the percentage of the fuel additive out of the total fuel may be within a range of 3% to 15%, inclusive.

In the fuel cell system according to this aspect, the fuel supply portion may also supply a conductive agent formed of ion-conducting material, together with the main fuel.

According to this structure, the fuel supply portion also supplies a conductive agent formed of ion-conducting material, together with the main fuel. This enables an adequate three-phase boundary to form around the catalyst particles of the anode. Therefore, the catalyst of the anode can be utilized effectively so that a larger reaction site area can be maintained, which in turn enables the power performance of the fuel cell to be improved.

In the fuel cell system according to this aspect, the electrolyte may conduct anions.

According to the structure described above, the electrolyte conducts anions. Supplying fuel in which a fuel additive has been added to a main fuel to an alkaline fuel cell that uses anions as the conductor in this way enables the power generating performance of the alkaline fuel cell to be more reliably improved.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a diagram showing the structure of a fuel cell system according to an example embodiment of the invention;

FIG. 2 is a graph showing the measurement results of current density and voltage of the fuel cell in the example embodiment of the invention; and

FIG. 3 is a graph showing the measurement results of current density and voltage of the fuel cell in the example embodiment of the invention.

### DETAILED DESCRIPTION OF EMBODIMENTS

Example embodiments of the present invention will be described in greater detail below with reference to the accompanying drawings. Incidentally, like or corresponding parts will be denoted by like reference characters and descriptions of those parts will be simplified or omitted.

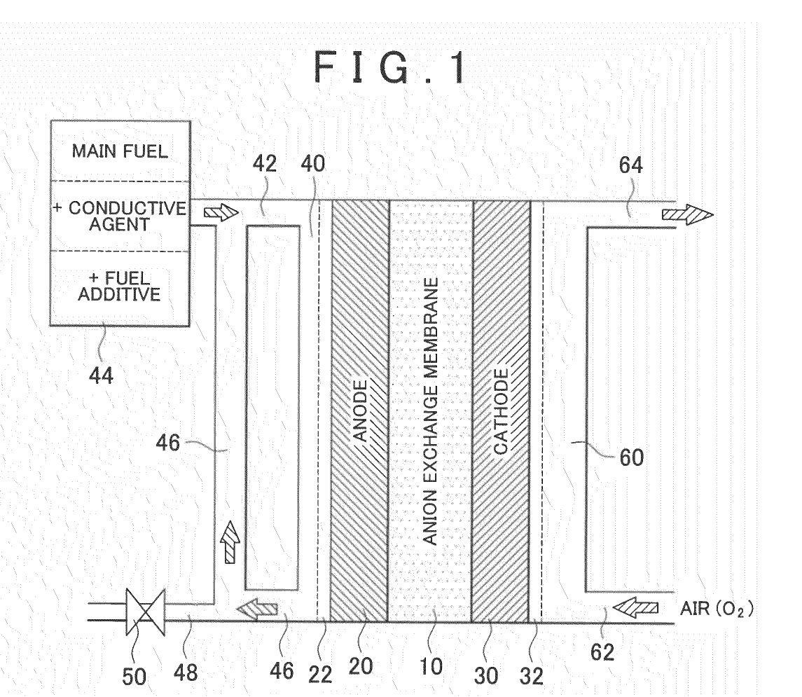

FIG. 1 is a diagram showing the structure of a fuel cell system according to an example embodiment of the invention. The fuel cell shown in FIG. 1 is an alkaline fuel cell in which anions are used as a collector. The fuel cell has an anion exchange membrane 10 (i.e., an electrolyte). An anode 20 is arranged on one side of the anion exchange membrane 10, and a current collector 22 is arranged on the anode 20. A cathode 30 is arranged on the other side of the anion exchange membrane 10 (i.e., on the opposite side of the anion exchange membrane 10 from the anode 20), and a current collector 32 is arranged on the cathode 30.

A fuel path 40 through which fuel is supplied to the anode 20 is provided on the side of the anode 20 opposite the side that contacts the anion exchange membrane 10. The upstream side of the fuel path 40 is connected to a fuel supply passage 42 provided outside of the fuel cell. The fuel supply passage 42 is connected to a fuel supply source 44. The downstream side of the fuel path 40 is connected to a fuel recirculation passage 46. The fuel recirculation passage 46 is connected to the fuel supply passage 42 on the side opposite the portion where the fuel supply passage 42 is connected with the fuel flow path 40. The fuel recirculation passage 46 branches off midway from the recirculation system and connects to a fuel discharge passage 48. A valve 50 that opens and closes the fuel discharge passage 48 is provided in the fuel discharge passage 48. The opening and closing of the valve 50 is controlled by a control unit, not shown. The fuel supply passage 42 is an example of a supply portion of the invention.

Also, an oxygen flow path 60 is provided on the side of the cathode 30 opposite the side that contacts the anion exchange membrane 10. An oxygen supply passage 62 is connected to the upstream portion of the oxygen flow path 60, and an oxygen discharge passage 64 is connected to the downstream portion of the oxygen flow path 60.

In this type of fuel cell system, fuel which will be described later is supplied from the fuel supply source 44. The supplied fuel flows through the fuel flow path 40 via the fuel supply passage 42 and is discharged to the fuel recirculation passage 46. During normal operation of the fuel cell, the valve 50 is closed such that the fuel discharged from the fuel flow path 40 (hereinafter referred to as “used fuel”) flows into the fuel supply passage 42 through the fuel recirculation passage 46 and is supplied back into the fuel flow path 40 as fuel again. That is, this fuel cell system repeatedly uses the fuel by recirculating it.

However, when the fuel cell is operated for an extended period of time, the fuel concentration gradually decreases. When the fuel concentration has decreased, the valve 50 is opened to discharge the used fuel out of the fuel cell, and a fresh supply of fuel is introduced from the fuel supply source 44. The determination as to whether the fuel concentration has decreased is made based on whether the output of the fuel cell has decreased to a predetermined determining value or lower, for example.

Meanwhile, air is introduced from outside the fuel cell through the oxygen supply passage 62, and supplied as the oxidant to the oxygen flow path 60 of the cathode 30. Air-off gas that includes unreacted oxygen discharged from the cathode 30 is discharged outside of the fuel cell through the oxygen discharge passage 64.

Here, the fuel supplied to the anode 20 is broken down by the electrocatalytic function of the anode 20 into hydrogen atoms which react with the hydroxide ions (OH⁻) that have passed through the anion exchange membrane 10, thereby producing water (H₂O). At this time, the released electrons pass from the current collector 22 through an external circuit to the current collector 32 on the cathode side. More specifically, when pure hydrogen, for example, is broken down in the process of breaking the fuel down at the anode 20, the reaction shown in Expression (1) below takes place.

H₂+2OH⁻→2H₂O+2e⁻ (1)

Also, when ethanol, for example, is supplied as the fuel to the anode 20 and broken down, the reaction shown in Expression (2) below takes place.

CH₃CH₂OH+12OH⁺→2CO₂+9H₂O+12e⁻ (2)

Meanwhile, when air is supplied to the cathode 30, the electrocatalytic function of the cathode 30 causes the oxygen molecules (O₂) in the air to pass through several stages during which they take on electrons, which results in the formation of hydroxide ions. These hydroxide ions pass through the anion exchange membrane 10 to the anode 20 side. The reaction at the cathode 30 is as shown in Expression (3) below.

1/2O₂+H₂O+2e⁻→2OH⁻ (3)

When the reaction at the anode 20 and the reaction at the cathode 30 are combined, a water-forming reaction as shown in Expression (4) below takes place in the fuel cell as a whole, and electrons move through an external electrical circuit between the current collectors 22 and 32 on the electrodes and perform work on a load in the circuit, thereby producing energy.

H₂+1/2O₂→H₂O (4)

In this kind of alkaline fuel cell, the anion exchange membrane 10 is not particularly limited as long as it is a medium that enables hydroxide ions produced at the electrocatalyst of the cathode 30 to move to the anode 20 side. More specifically, the anion exchange membrane 10 may be, for example, a polymer electrolyte membrane (an anion exchange resin) having an anion exchange group such as a primary to tertiary amino group, a quaternary ammonium group, a pyridyl group, an imidazole group, a quaternary pyridium group, and a quaternary imidazolium group or the like. Also, the polymer electrolyte membrane may be, for example, a hydrocarbon or fluorine resin or the like.

Both the anode 20 and the cathode 30 at least have an electrode catalyst layer formed by applying an electrolyte solution into which catalyst particles have been mixed onto the anion exchange membrane 10. These electrode catalyst layers are not particularly limited as long as they function to catalyze the reaction of (1), (2), or (3) above. More specifically, the catalyst particles of the electrode catalyst layers of the anode 20 and the cathode 30 may be, for example, formed of i) iron (Fe), platinum (Pt), cobalt (Co), or nickel (Ni), ii) a carrier such as carbon carrying one of those metals, iii) an organometallic complex in which the atoms of one of those metals is the central metal, or iv) a carrier carrying such an organometallic complex.

Incidentally, in this example embodiment, in order to improve the breakdown efficiency of the fuel at the anode 20 and maintain high performance of the fuel cell even when it is operated for an extended period of time, a mixture of i) a main fuel that is normally used as fuel for a fuel cell, ii) a conductive agent, and iii) a fuel additive of a hydrogen-containing compound, is used as the fuel supplied from the fuel supply source 44.

More specifically, the main fuel that is used includes hydrogen and carbon. More specifically, alcohol, methane, or dimethylethyl or the like may be used, for example. Methanol, ethanol, ethylene glycol, or propanol, for example, may be used as the alcohol. However, because a fuel additive and a conductive agent are mixed in with the fuel that is supplied, the main fuel is preferably a liquid or soluble at room temperature, such as ethanol. Ethanol in particular can be obtained easily at a relative low cost, which also makes it effective for reducing the cost of the fuel cell.

The conductive agent is formed of ion-conducting material that functions similar to the anion exchange membrane 10, i.e., it conducts hydroxide ions. As described above, the hydroxide ions that have passed through the anion exchange membrane 10 bond with the hydrogen that has separated from the fuel on the catalyst particles of the anode 20, and in doing so, release electrons. Here, in order for the hydroxide ions to reach the catalyst particles of the anode 20, a three-phase boundary of the fuel, electrolyte, and catalyst particles must be formed, which means that electrolyte solution that carries hydroxide ions must be present around the catalyst particles. However, in some cases, at some of the catalyst particles of the anode 20 there are portions where the three-phase boundary does not form due to the absence of electrolyte solution, or portions where the three-phase boundary is unable to be maintained due to the electrolyte solution flowing out or degrading. In these cases, these portions are unable to function as reaction sites for the electrochemical reaction at the anode.

Therefore, in this example embodiment, the main fuel is supplied with a conductive agent of ion-conducting material mixed in. This enables an ion-conducting substance to be supplied around the catalyst particles such that the area around the catalyst particles is in the same state that it would be in if electrolyte solution was present. Therefore, the three-phase boundary can be adequately formed around the catalyst particles, thus ensuring a large number of reaction sites at the anode 20. As a result, the power generating performance of the fuel cell can be improved.

This kind of conductive agent is not particularly limited as long as it functions to conduct hydroxide ions through the anode 20, i.e., as long as it produces an alkaline atmosphere in the anode 20. Therefore, for example, a solution of potassium hydroxide or sodium hydroxide or the like, or material similar to the material of which the anion exchange membrane 10 is formed, triethanolamine (C₆H₁₅NO₃), triethylenediamine (C₄H₁₂N₁₂), tetraethylenediamine (C₄H₁₂N₂), or an imidazolium compound or the like may be used.

Moreover, in this example embodiment, the main fuel is supplied with a fuel additive mixed in. This fuel additive is a hydrogen-containing compound and is formed of material that has a lower oxidation-reduction potential than that of hydrogen. This fuel additive foams and releases hydrogen when it comes into contact with the catalyst of the anode 20.

As described above, the main fuel that is used includes carbon and thus produces carbon dioxide as it breaks down. This carbon dioxide may cause the anion exchange membrane 10 and the electrocatalyst of the anode 20 to oxidize and degrade. However, according to this example embodiment, the hydrogen that foams when the fuel additive comes into contact with the catalyst is able to reduce the oxidized anion exchange membrane 10 and electrocatalyst of the anode 20. Therefore, even if the fuel cell is operated for an extended period of time, degradation of the anion exchange membrane 10 and the anode 20 can be suppressed. That is, even if the fuel cell is operated for an extended period of time, the high performance of the electrocatalyst of the anode 20 can be maintained, such that high power generating performance of the fuel cell can be maintained.

Also, the hydrogen produced by the fuel additive can be broken down as shown in Expression (1) above and used to generate power in the fuel cell. Accordingly, high output of the fuel cell can be maintained even when the fuel additive is added to the main fuel.

This kind of fuel additive is a hydrogen-containing compound and is formed of material that has a lower redox potential than that of hydrogen. More specifically, for example, the fuel additive is preferably a salt that makes an aqueous solution alkaline or neutral. Also, the fuel additive preferably includes an alkali metal or an alkaline earth metal. More specifically, the fuel additive is preferably NaH₂PO₂, NaH₂PO₄, Na₂HPO₄, KH₂PO₂, KH₂PO₄, K₂HPO₄, or NaBH₄, or a compound of these. When these aqueous solutions come into contact with the catalyst, hydrogen foams and in the process, the anion exchange membrane 10 and the anode 20 can be reduced. Also, in order to ensure high output from the fuel cell, it is preferable to use a fuel additive that results in more hydrogen foaming, i.e., that contains more hydrogen atoms. Therefore, NaH₂PO₂, NaH₂PO₄, KH₂PO₂, and KH₂PO₄, or the like in particular are considered effective.

The amount of fuel additive that is added is not particularly limited. However, it is preferable that enough fuel additive be mixed in to not only efficiently reduce the anion exchange membrane 10 and the anode 20, but to keep on efficiently reducing the anion exchange membrane 10 and the anode 20 even when the fuel cell is operated for an extended period of time. On the other hand, hydrogen foams when the fuel additive comes into contact with the catalyst of the anode 20, but if there is too much foaming hydrogen, the bubbles may adhere to the catalyst particles and actually end up reducing the number of reaction sites. This decrease in the number of reaction sites can be suppressed by increasing the flowrate of the fuel that flows to the fuel flow path 40, for example. However, if the flowrate of the fuel is increased too much, it may promote the degradation of the fuel cell. Therefore, it is preferable that the amount of the fuel additive that is mixed in be such that the adhesion of foamed hydrogen to the catalyst particles is kept within an acceptable range, at a fuel flowrate that is within a range that does not promote the degradation of the fuel cell.

Accordingly, the amount of fuel additive that is added is preferably determined to be within a range with a lower limit that is an amount that enables the anion exchange membrane 10 and the anode 20 to be effectively reduced, and an upper limit that is an amount at which the decrease in the number of reaction sites due to the adhesion of foamed hydrogen is within an acceptable range, at a fuel flowrate that ensures the durability of the fuel cell. In terms of a specific range, the ratio of the fuel additive to the main fuel is preferably at least 3% and no more than 20%. A range of approximately 5% to 15%, inclusive, is thought to be particularly effective.

As described above, according to this example embodiment, the fuel that is used is a mixture in which a conductive agent and a fuel additive have been added to a main fuel that includes carbon and hydrogen, such as alcohol. As a result, the fuel more actively breaks down at the anode 20, which further improves the power generating performance of the fuel cell. In addition, degradation is suppressed by reducing the oxidized anion exchange membrane 10 and anode 20, which enables high power generating performance of the fuel cell to be maintained even when the fuel cell is used for an extended period of time.

Incidentally, this example embodiment describes a case in which the fuel additive and the conductive agent are mixed in with the main fuel. However, the invention is not limited to this. For example, the conductive agent does not have to be added (i.e., it may be omitted). The conductive agent is mixed in with the fuel in order to form an adequate three-phase boundary. However, the effect from the fuel additive which improves power generating performance by suppressing degradation of the fuel cell can still be obtained even if the conductive agent is not added.

Also, this example embodiment describes a case in which the fuel that is supplied from the fuel supply source 44 is a mixture in which a fuel additive and a conductive agent are mixed with a main fuel. However, the invention is not limited to this. For example, the supply source for the main fuel may be separate from the supply source for the fuel additive and conductive agent, and the main fuel and the fuel additive and conductive agent may be supplied while adjusting their concentration.

Also, this example embodiment describes a case with a structure in which the fuel is recirculated and reused, and is only discharged by opening the valve 50 when the concentration has dropped to a certain degree. However, the invention is not limited to this. For example, the structure may also be such that the used fuel may be constantly discharged outside the fuel cell and only fresh fuel supplied from the fuel supply source 44 is supplied to the fuel flow path 40. Alternatively, fuel may be held in the fuel flow path 40 without being recirculated or discharged until the fuel concentration drops. However, because hydrogen foams when the fuel additive comes into contact with the catalyst particles, it may adhere to the catalyst particles and this adhered hydrogen may be difficult to remove if fuel is not flowing. Therefore, with a structure in which fuel is held in the fuel flow path 40, it is preferable to incorporate a function to remove any adhered hydrogen, such as the use of an oscillator for example, to inhibit a decrease in the reaction surface due to adhered hydrogen.

Also, for the sake of simplification, this example embodiment describes a case in which the fuel cell has one power generating portion formed of the anion exchange membrane 10 and the pair of electrodes (i.e., the anode 20 and the cathode 30) arranged one on either side of the anion exchange membrane 10. However, the fuel cell in the invention is not limited to this. For example, the fuel cell may have a stack structure in which a plurality of power generating portions are stacked via current collectors and separators. In this case as well, the power generating performance of the fuel cell can be improved by supplying fuel to which a fuel additive such as that described above has been added.

Also, this example embodiment describes a case in which the fuel cell is an alkaline fuel cell that uses the anion exchange membrane 10. However, the invention is not limited to this kind of fuel cell. That is, the invention may also be applied to an alkaline fuel cell that uses an electrolyte that conducts anions, such as KOH or the like, instead of the anion exchange membrane, for example. Also, depending on the type of fuel additive, the invention is not limited to an alkaline fuel cell, but may also be applied to a polymer electrolyte fuel cell that uses a polymer electrolyte membrane, for example.

Also, the invention is not limited to the numbers used to indicate number of elements, quantities, amounts, and ranges and the like referred to in this example embodiment. Similarly, the structure and the like of the invention are not limited to that described in this example embodiment.

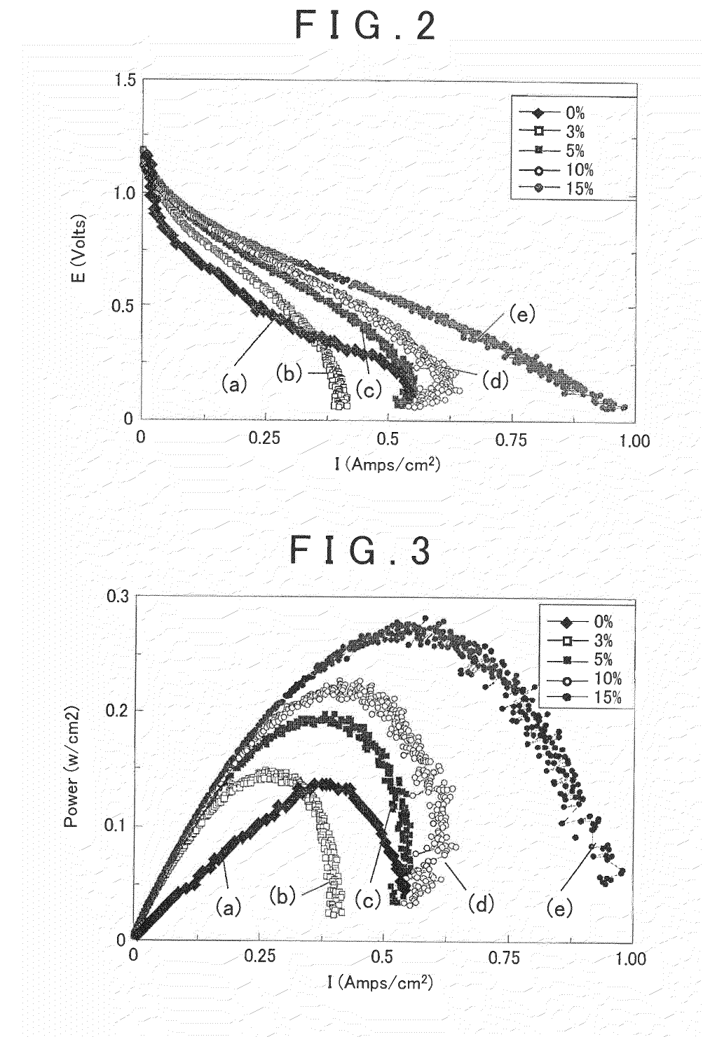

FIG. 2 is a graph showing the relationship between current density and voltage when the concentration of the fuel additive in the fuel is changed, and FIG. 3 is a graph showing the relationship between current density and power density when the concentration of the fuel additive in the fuel is changed. In FIG. 2, the horizontal axis represents the current density [Amps/cm²] and the vertical axis represents the voltage [V]. In FIG. 3, the horizontal axis represents the current density [Amps/cm²] and the vertical axis represents the power density [W/cm²].

The experiment was performed using a fuel cell with an anion exchange membrane 10 that is 40 [μm] thick and having a reaction surface that measures 19 [mm] by 27 [mm]. The flowrate of the fuel was 200 [ml/min] and the operating temperature was 80[° C.]. 10% ethanol aqueous solution was used as the main fuel and the concentration of KOH, which was the conductive agent, with respect to the main fuel was 10%. NaH₂PO₂ was used as the fuel additive. The concentrations of the fuel additive with respect to the main fuel were 0%, 3%, 5%, 10%, and 15%, and the current density, voltage, and power density were detected at each concentration. The curved lines (a), (b), (c), (d), and (e) in FIGS. 2 and 3 indicate when the concentration of the fuel additive was 0%, 3%, 5%, 10%, and 15%, respectively.

From FIGS. 2 and 3, it is evident that in all cases in which the fuel additive was added (i.e., with curved lines (b) to (e)), the values of both the voltage [V] and the power density [W/cm²] were high, meaning that power generating performance was improved, in the region where the current density is equal to or less than approximately 0.3 [Amps/cm²] compared to the case in which no fuel additive NaH₂PO₂ was added (i.e., when the added amount was 0 as shown by curved line (a)). Also, high voltage and power density were able to be obtained throughout the entire measured region of the current density (i.e., 0 to 1.00 [Amps/cm²] when 5% or more of the fuel additive was added (i.e., with curved lines (c) to (e)) compared to when the fuel additive was not added.

What is claimed is:

1. Fuel for a fuel cell, comprising:
a main fuel that includes at least hydrogen and carbon; and
a fuel additive formed of a hydrogen-containing compound that has a redox potential lower than that of hydrogen.

2. The fuel for a fuel cell according to claim 1, wherein the fuel additive includes a salt that makes an aqueous solution alkaline or neutral.

3. The fuel for a fuel cell according to claim 1, wherein the fuel additive includes an alkali metal or an alkaline earth metal.

4. The fuel for a fuel cell according to claim 1, wherein the fuel additive includes at least one selected from the group consisting of NaH₂PO₂, NaH₂PO₄, Na₂HPO₄, KH₂PO₂, KH₂PO₄, K₂HPO₄, and NaBH₄.

5. The fuel for a fuel cell according to claim 1, wherein the percentage of the fuel additive with respect to the main fuel is within a range of 3% to 15%, inclusive.

6. The fuel for a fuel cell according to claim 1, further comprising a conductive agent formed of ion-conducting material.

7. A fuel cell system comprising:
an electrolyte;
an anode arranged on one side of the electrolyte and a cathode arranged on the other side of the electrolyte; and
a fuel supply portion which supplies a main fuel that includes at least hydrogen and carbon, and a fuel additive formed of a hydrogen-containing compound that has a redox potential lower than that of hydrogen, to the anode.

8. The fuel cell system according to claim 7, wherein the fuel additive includes a salt that makes an aqueous solution alkaline or neutral.

9. The fuel cell system according to claim 7, wherein the fuel additive includes an alkali metal or an alkaline earth metal.

10. The fuel cell system according to claim 7, wherein the fuel additive includes at least one selected from the group consisting of NaH₂PO₂, NaH₂PO₄, Na₂HPO₄, KH₂PO₂, KH₂PO₄, K₂HPO₄, and NaBH₄.

11. The fuel cell system according to claim 7, wherein the percentage of the fuel additive out of the total fuel is within a range of 3% to 15%, inclusive.

12. The fuel cell system according to claim 7, wherein the fuel supply portion also supplies a conductive agent formed of ion-conducting material, together with the main fuel.

13. The fuel cell system according to claim 7, wherein the electrolyte conducts anions.
